(19) United States
(12) Patent Application Publication
(10) Pub. No.: US 2010/0070312 A1
(43) Pub. Date: Mar. 18, 2010

(54) Universal Ticketing and Payment System

(76) Inventor: Andrew Stuart HUNT, Dallas, TX (US)

Correspondence Address: HITCHCOCK EVERT LLP, P.O. BOX 131709, DALLAS, TX, 75313-1709, US

(21) Appl. No.: 12/560,269

(22) Filed: Sep. 15, 2009

Related U.S. Application Data
(60) Provisional application No. 61/192,065, filed on Sep. 15, 2008.

(51) Int. Cl. G06Q 50/00; G06Q 30/00; G06Q 10/00; G06Q 20/00; G06F 17/00; G06K 19/06

(52) U.S. Cl. 705/5; 705/14.25; 705/325; 235/375; 235/494

(57) ABSTRACT

A remotely-accessible computer system allows a purchase to establish an account and then purchase admission to live events or venues. The system provides the purchaser with a pass containing data identifying the account established for the purchaser which account contains information about purchased admissions. The pass can be used to gain access multiple events. The purchaser presents the pass at the entrance to the event and a reader reads the identification data and forwards it to the system. The system checks that the purchaser has purchased entry to the particular event and provides a signal to the event indicating whether admission to the event should be allowed or refused.

### CROSS-REFERENCE TO RELATED APPLICATION

This application claims the benefit of priority from U.S. Provisional Application No. 61/192,065 filed on Sep. 15, 2008.

### FIELD OF THE INVENTION

This invention relates to the sale of admissions to live events and amusement venues.

### BACKGROUND OF INVENTION

For as long as anyone can remember, the paper ticket has served event managers as the most widely used and effective tool to control access to live events. Relatively inexpensive to manufacture and distribute, the paper ticket system has provided event managers with a simple and cost-effective way to ensure that only paying customers gain access to an event. Over time the paper ticket system has become the target of counterfeiters who have taken advantage of the advances in printing technologies to manufacture fake paper tickets to popular events such as the Olympics and Super Bowl. In response to this counterfeiting epidemic, event managers have had to spend more money making paper tickets harder to counterfeit by using higher grade inks and paper stock, holograms, and barcode technologies. As a consequence of the burden on event managers to ensure that only paying patrons gain entry to an event and to provide consumers with the peace of mind that they are buying authentic tickets, the costs of manufacturing and distributing paper tickets has been increasing significantly every year. Due to the threat of paper ticket counterfeiting and the associated rising costs stemming from counterfeit prevention, it is becoming clear that the conventional, old-fashioned paper ticket methodology may no longer be the most efficient system for providing access control to live events.

Online ticket sales for live events such as concerts and sporting events have become a very common practice over the past few years. Companies such as StubHub, Ticketmaster, and Tickets.com dominate the online event ticket market and patrons to events have become accustomed to using these internet-based ticketing services to search for and purchase tickets to live events around the world. Distribution of event tickets purchased online is currently handled in several ways. At the time of purchase of tickets the purchaser can choose to have paper tickets sent to a physical address (home or office for example) in the mail, or via a delivery company such as UPS or FedEx. The cost of shipping, however, adds additional expense to the cost of event tickets, which is ultimately passed on to the purchaser. Further complicating this online event ticket distribution system is the fact that tickets are frequently lost in the mail and can take days to deliver, which may be a problem for people traveling or who do not receive their tickets in the mail before the event date.

Another online ticket distribution method that is becoming very popular with both the online ticket broker and the purchasers of event tickets is for the purchaser to print out a purchased event ticket using the purchaser's own printer. In this ‘print at home’ scenario a confirmation barcode is printed on the ‘print at home’ document, which enables it to be scanned at the event by an event gate keeper using a barcode reader. This ‘print at home’ e-ticket system provides the bearer of an e-ticket access to the event just as if they presented a conventional paper ticket. The ‘print at home’ ticket may include other pertinent information such as the name and address of the purchaser, specific seating information and other privileges. Typically the broker, such as Ticketmaster, will have an email address on file and will send the e-ticket to the purchaser via electronic mail (e-mail). Many managers of events prefer this ‘print at home’ ticket because it is more convenient for their patrons and costs less than manufacturing and distributing old-fashioned paper tickets via ‘snail’ mail. It is more convenient for the purchaser because the event e-tickets can be printed off 24 hours a day, and patrons do not have to worry about their tickets being lost in the mail or having to stand in line at will call at the venue to pick up their event tickets.

More recently, major venue operators such as Live Nation, a spinoff of Clear Channel that manages more than 10,000 live events worldwide each year, have made a commitment to sell more event tickets to the venues they own or manage using their official corporate site (www.livenation.com) as opposed to sharing the revenue from ticket sales with online ticket brokerage companies such as Ticketmaster. To persuade consumers to buy directly from Live Nation rather than from a broker, Live Nation has implemented a Fast Lane program that provides patrons who purchase tickets at www.livenation.com with an exclusive VIP line at participating events that gets them into the event faster. This Live Nation Fast Lane system allows consumers to print out an event e-ticket and a Fast Lane proof of purchase e-document (a piece of paper with a barcode printed on it), which is scanned by the gate keeper at the event.

Companies such as Proximities (recently acquired by Bartronics America) and Precision Dynamics (PDC) have developed alternatives to using the conventional paper ticket for access to venues such as water parks and amusement parks. These solutions focus mainly on offering convenience to guests and reducing ticket fraud by providing non-transferable and non-reusable RFID-enabled bracelets for access control and other applications, such as point of sales (POS) purchases at places such as amusement parks, hospitals and ski resorts.

Previous alternative paper ticket solutions are closed loop systems focused on providing access control and payment solutions for a particular operator and typically for just one physical location managed or operated by that single operator. For example Proximities' preferred solution has been to provide a single client with barcode or RFID-enabled bracelets to replace paper tickets that can be used by patrons as an admissions ticket and as a payment option, which presumably adds convenience for guests and fraud prevention for the amusement park operator. Proximities' U.S. Pat. No. 7,042,357 discloses an RFID-enabled bracelet ticket is contemplated that deactivates the access privileges and payment application when taken off the wrist of the original purchaser to combat fraud stemming from the unscrupulous practice of transferring an admission ticket to someone who never paid for admission to the amusement park. Deactivating the bracelet and making it impossible to transfer or reuse once the bracelet is taken off the wrist clearly is a desirable solution for the operator of the amusement park who loses money each time guests share their admissions ticket with friends and family who may not have paid for access privileges. In this closed loop system, the RFID-enabled bracelet itself has no value or practical usefulness once it is taken off the wrist and cannot be used outside of the venue or event for which it was designed. Proximities' non-reusable bracelet event tickets are good for use only at a single venue and therefore are not reusable or functional at other events or venues.

The present invention uses a barcode and/or RFID-enabled ticket or pass containing data identifying the patron as a device that event patrons use for POS payments and admission to events. The ticket may conveniently be in the form of a wrist bracelet that the user can wear to the event or venue, but, as will be readily apparent to those skilled in the art, the barcode or RFID-enabled device could take many forms, including a card, similar to a conventional credit card, a key fob, RFID sticker or a souvenir or promotional item. In one form of the invention, the identity data is transmitted to the patron's cell phone or other pda and can be displayed on the cell phone screen or transmitted by the cell phone. The term “pass” as used in this specification and claims is to be understood to include these alternative forms of platform for the barcode or RFID device.

### SUMMARY OF THE INVENTION

In a departure from the prior art, however, the present invention uses an open loop system that benefits the consumer by providing a single barcode and/or RFID-enabled pass that is reusable at a plurality of different events and venues. The present invention focuses on developing a convenient universal ticketing and payment system that allows consumers the added convenience and functionality of a single reusable pass that can be used at a plurality of events across different geographical locations, which may even be managed by unaffiliated event operators.

Essentially the prior art is locked in the old fashioned paper ticket model that provides a one-use ticket for one event or venue. In the present invention once the patron activates his pass or bracelet ticket, he is free to write his own ticket to a network of live events using that one pass.

In one form of the invention a pass website prompts patrons to sign up to become a member of the universal event network by filling out a personal information profile which may include personal data, preferred contact information and credit/debit information. The web site may include a personal profile home page, providing an intuitive experience for patrons to manage their live events by searching for and buying event tickets, adding value to their pass profile, book hotel accommodations and airfare, write reviews for free rewards and more.

The unique RFID chip and/or barcode identifier implanted or printed on the pass of this invention links to a corresponding unique member's profile that includes all of the above personal and credit information and communicates with the computer data system when it is scanned by a reader at an event or venue. After the pass is scanned by the reader, the privileges associated with that individual spectator's pass account are verified by the computer data system. Privileges being verified by the pass system may include access privileges (did this person buy a ticket to the event?) and purchasing power privileges (are there funds available on this account to pay for a purchase at the concession stand?) among others.

The present invention takes a novel and innovative approach to the out-dated ‘one physical ticket for one event’ conventional ticketing model by introducing a universal ticketing and payment system that offers consumers the ability to use one universal bracelet ticket that works at a multitude of venues across a network of live events.

Though there have been previous innovations which combine a bracelet with a barcode or RFID chip providing access control and payment applications by the competition and others who have developed online e-ticketing systems (such as Ticketmaster), the preferred forms of the present invention are superior to the prior art in many distinct and meaningful ways, including:
1. Replaces conventional paper tickets and e-tickets
2. Replaces the practice of printing out and bringing an additional ‘print at home’ e-ticket document for access privileges to events
3. Reduces threat of counterfeiting and associated costs associated with printing and distributing old-fashioned paper tickets
4. Increases convenience for spectators by combining access privileges with POS payment functionality among other privileges onto one universal pass that works seamlessly for such purposes across a network of live events
5. A payment system that tracks financial transactions at every event in the network back to a specific spectator's universal pass account
6. Provides valuable business intelligence and data mining opportunities concerning vendor sales, inventory and spectators' buying history and brand preferences
7. Reduces waiting time to gain admission to events and speeds up waiting lines at souvenir gift shops and concession stands
8. Cashless transactions have been shown to be higher value transactions
9. Reducing cash transactions at events reduces shrinkage and theft

In a further aspect of the present invention, combining the universal ticketing function with the payment application, the present invention also offers significant value for advertisers and corporate sponsors of live events. Currently there is no system in place that provides data linking transactions at live events back to a specific individual spectator. There is, of course, a large amount of general demographic information on spectators that attend particular events, such as the Super Bowl, that advertising agencies and corporate sponsors like Budweiser use on a regular basis to make marketing decisions and budget ad spends. However, this current demographic information is incomplete because it answers only in general terms of what types of people attend an event. It cannot answer the most important question: What is the individual John Smith buying at these live events? By combining the event ticketing application with the payment functionality onto one universal bracelet ticket device every transaction at every event across a network of live events can be traced back to a specific individual's pass account. And that would offer an incredible amount of extremely valuable business intelligence information beyond the general demographic info currently available to advertisers and corporate sponsors.

One of the major benefits of the pass system is that it offers event managers the capability to make events completely cashless if desired. A cashless event means that vendors and organizers need keep little or no cash on hand, which reduces shrinkage and theft. And because every transaction is tracked through the pass accounting system, organizers who take a percentage of total sales can hold vendors 100% accountable. Spectators to events using the pass will move through waiting lines faster and will have more time to enjoy the show. Research shows that cashless transactions are generally higher value compared to cash transactions and faster lines at concession stands will translate to more transactions per event. This means more revenue and profit for event organizers.

### BRIEF DESCRIPTION OF THE DRAWINGS

FIG. 1 is a diagram illustrating the steps for a patron to establish a WavPass account in accordance with the invention.

FIG. 2 is a diagram illustrating the use of the WavPass system by a patron at an event or venue in accordance with the invention.

FIG. 3 is a view of a wearable bracelet ticket with an RFID-enabled chip housed inside for use in the WavPass system of the invention.

FIG. 4 is a diagram illustrating the use of the wearable bracelet ticket of the WavPass system at an event.

FIG. 5 is a flow diagram showing in more detail how the WavPass system is used.

FIG. 6 is a flow diagram further illustrating the operation of the WavPass system.

### DETAILED DESCRIPTION

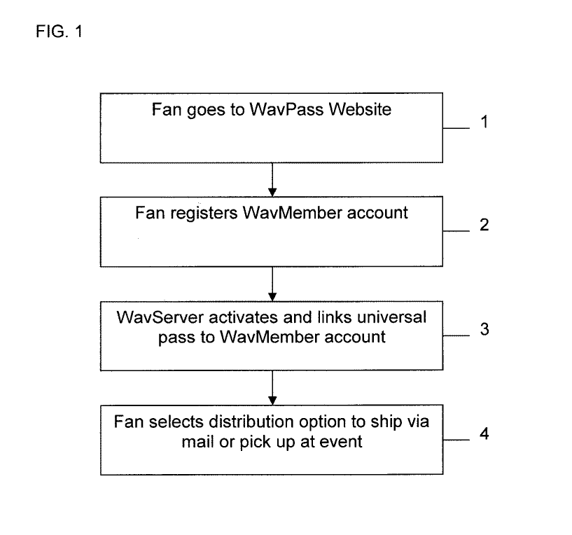

FIG. 1 illustrates the initial enrollment of a patron in the WavPass system. As shown at 1, a patron wishing to establish a WavPass account contacts the WavPass computer system using a network, such as the interne, and, at 2 using conventional browser technology, establishes an account on the system. The system, in a manner well understood in the art, obtains information from the patron, including name, address, email address, credit card information, all of which is stored in the system, at 3, and is associated with a WavMember account number record which is individual to that patron. At 4, the patron elects how to receive the WavPass pass or bracelet ticket from the system, for example, through the mail, or by collecting it at a specific location.

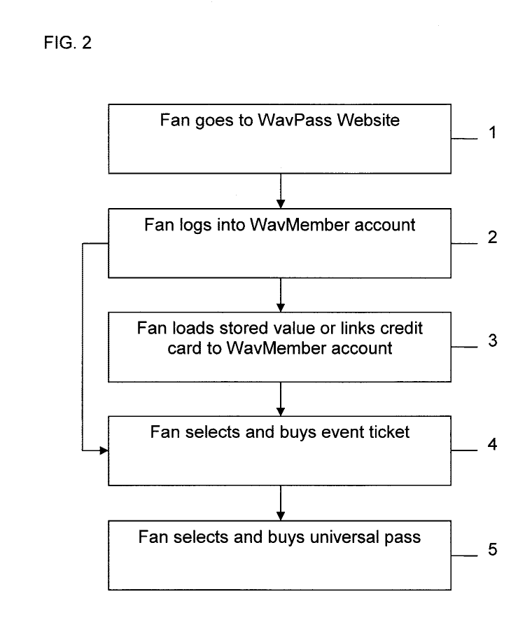

FIG. 2 shows how the patron uses the system, for example, to buy a ticket to an event or to enable the WavPass account to be used to purchase goods at events. As shown at 1, the patron goes to the WavPass website and, at 2, logs in using his WavMember account number and/or unique log-in and password information. The system, at 3, using software well known in the art, allows the patron to deposit money into the account for subsequent purchases, or enables the WavPass account to link to and charge debits to an existing credit or debit card account of the patron. Provided there is payment capability associated with the account, the system then at 4 allows the patron to purchase admission to an event, for example, an upcoming concert, and confirms the transaction and method of payment, e.g. charged to WavPass account or credit card account. The system may also provide the patron with information regarding the funds available in the WavPass account and other information, e.g. advertising for other upcoming events, reminders about events for which the patron has previously purchased admission.

Once the patron has established an account in the WavPass system and received the bracelet ticket containing the account identifying information, the patron can buy access to live events, such as concerts, or entertainment venues, such as theme parks, by accessing the WavPass system online. The public is already familiar with purchasing concert tickets and the like online and the technology needed to provide a web-based ticket purchase system is well understood and will not be described in detail in this patent.

Once the patron has purchased access, the details are stored in the computer system in association with the identifying data record for the patron's account and the patron is provided with confirmation of the purchase, including details of the event, such as location and time of the event, section to which admission is afforded and seat selected.

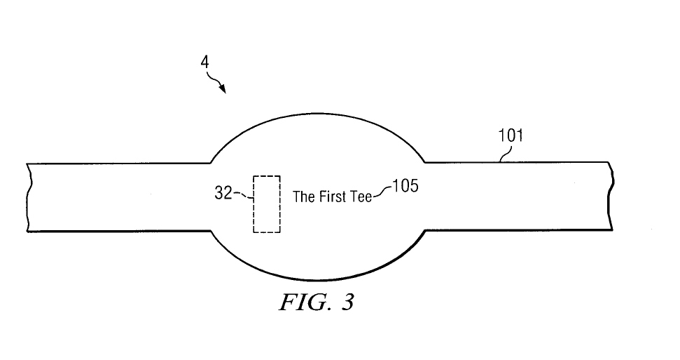

As discussed above, once the account is established, the system provides the patron with a pass used to gain entry to events and to make purchases at events using the WavPass system. Preferably, the pass is in the form of a bracelet ticket containing readable data identifying the patron's account. The data is preferably contained in an RFID chip device 32 embedded in a wearable bracelet 101, shown in FIG. 3.

Radio frequency identification, or RFID, is a generic term for technologies that use radio waves to automatically identify people or objects. There are several methods of identification, but the most common is to store a serial number that identifies a person or object, and perhaps other information, on a microchip that is attached to an antenna (the chip and the antenna together are called an RFID transponder or an RFID tag). The antenna enables the chip to transmit the identification information to a reader. The reader converts the radio waves reflected back from the RFID tag into digital information that can then be passed on to computers that can make use of it.

The RFID transponder chip device 32 (shown in phantom in FIG. 3) is housed within the bracelet ticket 4. The device 32 is arranged to function as a stored value card, or as a gift card, or as a debit or credit card linked to an established account at a financial institution, or a member's pass account. It can also allow the bracelet ticket 4 to function as a ticket for entry to a concert or other event, or to a particular seat or area, such as at a VIP enclosure, within the event. A barcode (not shown in FIG. 3) may also be applied to the exterior of the bracelet to be used for communications purposes, such as access control and payment applications described above.

The bracelet 4, shown in FIG. 3, itself contains a barcode and/or a RFID-enabled device that enables data to be stored and retrieved, transforming the bracelet into a communications device and allowing it to function as a wearable event ticket and as a payment device, obviating the need for a paper ticket or separate money card.

Preferably, the information is stored on the bracelet 4 by means of a contactless device receiving and transmitting data by, for example, radio frequency, such as the passive RFID chip devices developed by Texas Instruments. A conventional barcode or an antenna could be printed on the exterior of the bracelet using, for example, conductive inkjet technology developed by Carclo. In operation, the patron uses the bracelet 4 in the same manner in which conventional RFID bracelets are used. The bracelet 4 is attached to the wrist or other body part of the patron and then, when unique identification is necessary, the user must bring the bracelet 4 within a certain distance of an RFID reader (the “read range”), which transmits a wireless signal. When within that distance, the RFID chip 32 (shown in phantom in FIG. 3) will be powered by the wireless signal from the RFID reader and, in response, transmit to the RFID reader its own wireless signal representative of the unique information pre-stored or pre-programmed in the chip 32. The reader may be linked to a microprocessor having a database of relevant information pertaining to the unique bracelet identification or that communicates with the pass network database.

If the bracelet 4 is to be used in a live event setting, for example, the information stored in the system and associated with the unique information stored on the bracelet may include: age verification or special access privileges to allow access to age-restricted areas, a credit/debit account balance for payment of food and drink, parking privileges, and identification of the patron's favorite drink to facilitate placing orders in loud, crowded areas. It can also allow the bracelet 4 to function as a ticket for entry to a concert or other event, or to a particular seat or area, such as at a VIP enclosure, within the event. The bracelet 4 itself, because of the encoded identity linked to the account record in the system data, can function as a proof of purchase and as a wearable ‘ticket’ that allows the wearer to enter and exit the event or restricted areas in the event. In an alternative form of the invention some data, in addition to the unique identification data, is stored on the bracelet 4 to be read at the event location. This could include stored funds.

The use of barcode or Near-Field communication technology, such as a transponder RFID chip 32, allows the organizer of an event to scan people for admittance quickly and conveniently, much reducing the time taken to process people arriving for an event. If appropriate data is stored on the device or can be accessed by communication with a spectator's pass profile on the computer data network, the wearer is able to charge food, drinks and other goods and services offered for sale at the event either to a pre-established pass account, or based on a particular “value” initially stored in the device. Such stored-value and gift card technology is well understood. Preferably, additional value may be added to the bracelet at the event, that is to say, the patron can use cash or other funds to add to the funds available on the bracelet at the event. The wearer of the bracelet is able to purchase the additional value at an event and add that value to the bracelet. When the bracelet includes a transponder RFID chip insert, the bracelet may also function as a tracking device for children, the physically or mentally disabled and senior citizens attending the event who may suffer from a disease such as Alzheimer's.

Another example of an application of the bracelet 4 of the present invention is in an educational institution setting. As an example the bracelet 4 could function as a student's identification card and the photo identification and other pertinent information about the student could be stored on the unique transponder RFID chip 32 housed within. Furthermore, the bracelet 4 could also be used by students, faculty and staff members at universities, colleges or high schools to buy books, access dorms and secure campus buildings such as the gym, pay for food and drinks, for transportation, and as a paper ticket replacement to school sponsored events such as basketball and football games. The bracelet 4 can be printed or debossed with a name or logo, as seen at 105 in FIG. 3, and thus serve as a wearable souvenir ticket, pass or identification device, for example, at live musical or sporting events, campuses of educational institutions, hotels, cruise lines, amusement and water parks, or resorts.

Though the present invention in its preferred embodiment envisions using the barcode and/or RFID-enabled bracelet as the pass, other forms may be used for this purpose including, but not limited to a smart card, badge, key fob, RFID stickers (such as Go-Tags manufactured by First Data) or even a mobile phone or personal digital assistant that has built-in Near Field Communications technologies. As long as the RFID chip and/or barcode or other data housed within or on the pass can communicate with the readers at the events and to access a user's pass profile and associated privileges in the WavPass system, the form of the ticketing and payment device used for such purposes is secondary.

Alternatively, the data could be in the form of a barcode printed on the exterior of the pass, e.g. the bracelet ticket. In an alternative form of delivery, not shown, the account identity-identifying data is delivered to the patron online to the patron's computer for printing, or to another suitable device, such as a cell phone or personal digital assistant (“pda”), to be readable when displayed on the device's screen, or to be transmitted by the phone or pda.

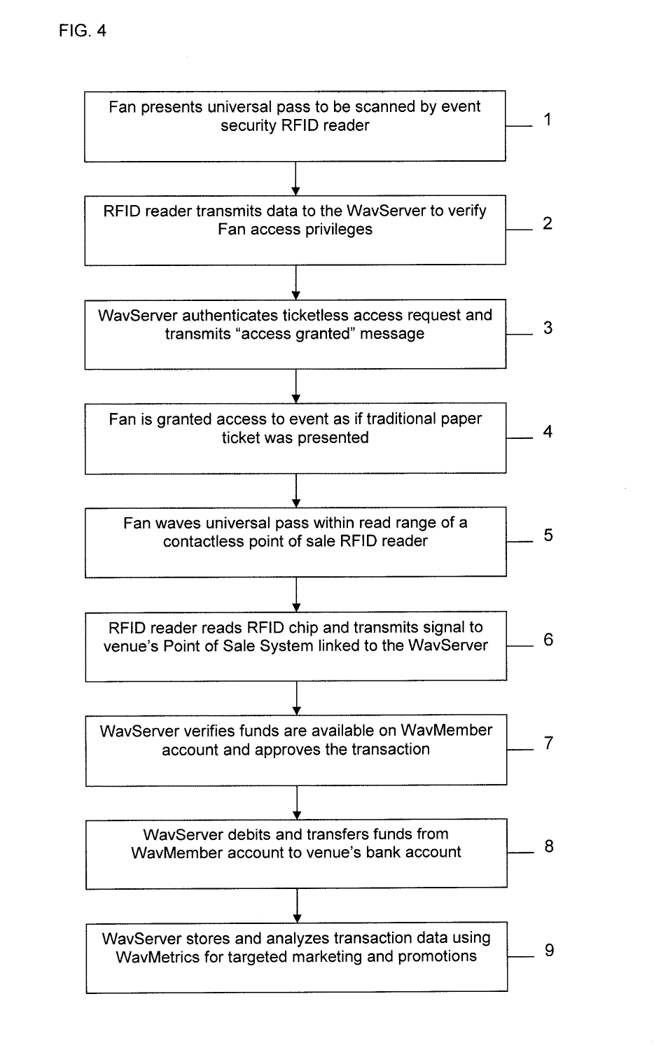

FIG. 4 shows the operation of the system at an event. As seen at 1, when the patron reaches the perimeter of the event, he produces the bracelet ticket which is read by a reader device at the perimeter. At 2, the reader device transmits a signal representative of the account identity to the WavPass computer system. The system at 3 interrogates the data stored in the system and, at 4, sends a reply signal to the event reader indicating whether access should be granted or denied.

FIG. 4 also shows use of the bracelet ticket at the event after access has been gained. The bracelet ticket can be used to purchase food, drink, souvenirs or other goods at a concession stand at the event. As shown at 5, the patron presents the bracelet ticket at a concession stand. A reader at the concession stand reads the bracelet ticket, step 6, and interrogates the WavPass system to ensure that sufficient credit or funds are available, step 7, in the patron's account to cover the purchase requested. If there is, the system signals the event staff managing the concession stand that the transaction can proceed. An appropriate debit transaction is made to the patron's account, step 8, and details of the transaction, what was purchased, where and when the purchase was made, and the cost of the purchase, are recorded in the account, step 9. The computer technology required to perform these steps is well known and established and does not form a part of the novel features of this invention.

It will be understood that, in practice, the funds transfer functions of the system may not happen in real-time and that funds may move between accounts at some time after the sale transaction is performed. Moreover, transfer of funds to the venue or to vendors will generally be batched and not handled as individual occurrences.

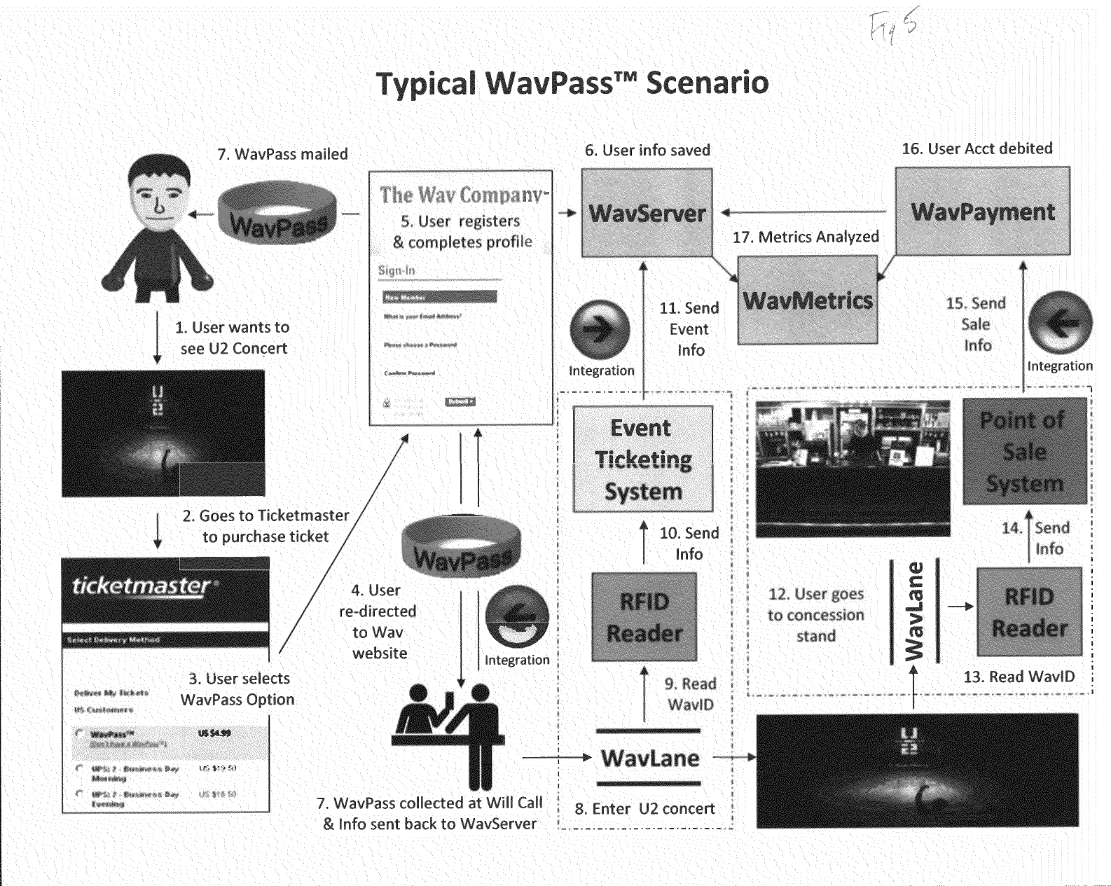

FIG. 5 is a flow diagram showing use of the system of the invention. As shown in FIG. 5, a fan 1 decides he wants to buy a ticket to a live event and first goes online to an online ticket broker website 2, such as (www.ticketmaster.com or www.livenation.com) to search for and purchase a ticket. As an alternative to selecting a delivery option, or print at home option (not shown), the fan 1 selects the WavPass option to use a reusable, universal bracelet ticket 4 for ticketless access to the event and is re-routed to the login page of a WavMember account 5 on the WavPass Website 3. The fan 1 then will log in to his personal WavMember account 5 or, if the fan 1 is a first time user, will register to become a member by filling out a personal profile and joining as a WavMember. The WavPass Website 3 offers members the ability to search, buy, sell, and trade event tickets, and use their reusable bracelet ticket 4 for expedited ticketless access and contactless payments at a multitude of live events.

In order to use the services offered on the WavPass Website 3, each fan 1 must sign up and fill out a personal WavMember account 5 with personal information that may include contact information such as a current mailing address, a personal email address, full name of WavMember, preferred contact phone number, and banking information, such as credit card or bank routing information. A database 6 of the WavSystem stores the WavMember account 5 profile information and activates a pass in the form of an RFID-enabled wristband 4 with unique data that is associated with a particular WavMember account 5. The WavMember account 5 may include event access privileges and stored value to be used by the fan 1 at live events to purchase concessions and merchandise. For security, no personal data or banking information is stored on the RFID chip housed within the pass 4, but data is stored on the secure WavServer 6.

Once the event ticket is purchased the fan 1, if a first time user, selects a preferred method of distribution for the pass 4, which can be sent in the mail via the delivery services provided by UPS for example. Alternatively, if desired, the fan 1 can pick up the pass 4 in person at the live event at a secure location such as Will Call 15.

Once at the event the fan 1 presents the pass 4 to be scanned by event security with a RFID reader 7, such as the readers marketed by NCR and others, which wirelessly reads the RFID chip inside the pass RFID-enabled wristband 4 and transmits data to the WavServer 6 database which verifies whether or not the ticket was in fact purchased for the event. The WavServer 6 authenticates the ticketless access request and transmits an ‘access granted’ message back to the RFID reader 7 and also updates the event ticketing system 8 so that the same pass 4 cannot be used again for reentry by another person for the same event. If the pass 4 is validated by the WavServer 6 the event security allows the fan 1 to access the event, just as if the fan 1 had presented a traditional paper event ticket. When this occurs, the record in the WavServer database is changed to reflect that access has been granted. If a second request for access to the event is received from the same pass, the request will be denied and the event notified.

At the discretion of the event producer a separate WavLane 9, similar to the Fast Lane provided by Live Nation, can be offered to holders of a pass 4 for expedited access to the event, as an added benefit to the fan 1 for being a WavMember.

Once inside the event the fan 1 can use the pass 4 as a contactless payment device to purchase concessions and merchandise. At the point of purchase, which in this example is at a concession stand 12, but could also be, for example, a gift shop, the fan 1 waves his pass 4 within read range of a contactless point of sale RFID reader 7, such as the contactless POS terminals marketed by First Data or ViVOtech, to make a contactless WavPayment 10. The RFID reader 7 reads the RFID chip housed within the pass 4 and transmits a signal to the venue's point of sale system 9, which is linked to the WavServer 6. The WavServer 6 verifies that the fan 1 has funds available on his WavMember account 5 to make said purchase and if funds are available the WavPayment 10 POS system approves the transaction. The WavServer 6 transfers the funds from the WavMember account 5 to the appropriate bank account specified by the event venue and the transaction is completed. Those skilled in the art will be aware that in such systems, the actual transfer of funds is typically a batched operation and that individual transfers of funds are not made with each transaction. The WavServer 6 stores all data related to purchases made by each fan 1 with a WavMember account 5 and can analyze all transactions using analytics software, known in the data mining field, and produces data that can be used for behavioral marketing and promotional campaigns encompassing statistical measurements, such as demographic information, brand preferences, purchase history, events attended, average spend per event and the like.

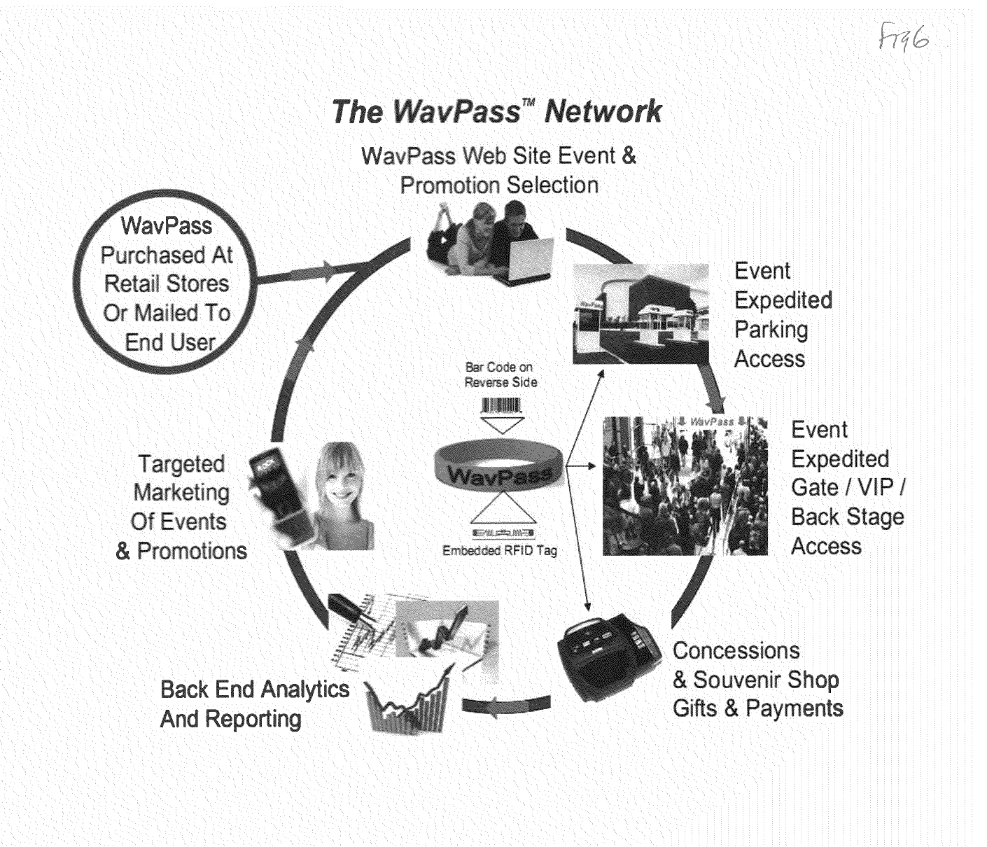

FIG. 6 is a flow diagram that shows some of the main features and benefits provided to the fan 1 utilizing the pass 4 of the present invention for ticketless access and contactless payments at live events. The fan 1 purchases a pass 4 online, in the manner described above, or in a retail store. When a pass 4 is purchased at a retail store the fan 1 must manually activate his pass 4 online by logging into the WavPass Website 3 and typing in the unique serial number associated with his WavMember account 5 which can be located on the pass 4 and/or inside or on the packaging in which the pass 4 is delivered. Alternatively, the pass 4 can be activated by the store employee at the point of sale. Alternatively, kiosks with an interne connection could be made available onsite at retail partner stores or event venues for the fan 1 to activate the pass 4 by logging into his WavMember account 5.

Once the pass 4 is activated for ticketless access and associated with the WavMember account 5 the fan 1 can purchase an event ticket on the WavPass Website 3, or an affiliate site. The fan 1 can then go to the event and use his pass 4 for expedited parking access 13 and expedited VIP access using the WavLane 9. The fan 1 can also use the pass 4 to make contactless transactions at concessions stands and gift shops using the WavPayment 10 POS system. The WavServer 6 tracks all ticketless access and POS transactions and the WavMetrics 11 analytics software mines the data for use in targeted marketing and promotions 14 which may include offering discounts to WavMembers on concessions, event tickets, downloadable music, merchandise, and sponsors' goods and services. Targeted marketing and promotions 14 can be delivered using the WavServer 6 to the fan 1 via email campaigns, on a mobile phone, or other mobile devices and when the fan 1 logs into his WavMember account 5 on the WavPass Website 3.

Another aspect of the invention offers an efficient ticketless method for ticket inventory management for companies that have for example season tickets, corporate boxes at arenas and stadiums or ticket inventory for live sports and music events at various venues which may be located in several cities or geographical locations. For example Company X provides the Company's authorized administrator total access and management privileges to the Company's WavMember account 5 and its entire inventory of event tickets. The authorized administrator can purchase event tickets and allocate tickets to employees based on company policy and rank of employee all through the Company X WavMember account 5. So, for example, Employee V of Company X requests tickets for Event Y via email and the authorized administrator at Company X approves or denies the request. If the request for tickets is approved the administrator logs into the Company X WavMember account 5, selects the tickets for Event Y and transfers access privileges to the Employee V WavMember account 5 for Event Y.

If approved and appropriate, Employee V may also use the pass to make POS transactions at Event Y, which will be documented as a Company X entertainment expense. Every transaction is tracked by the WavServer 6 at the event and either debited from the Company X pre-paid account or charged to the Company or Employee V credit card on file on the WavServer 6.

The Employee V can also transfer access privileges to a Company X Client R for Event Y and load funds onto the Client R pass or separate WavMember account 5 if approved as a valid business expense by the authorized administrator. The WavPass System provides the Employee V and Company X administrator an in-depth report for expense reporting compliance showing, for example, ticket usage, funds spent at events by individual employees and in total for Company X and the purpose for the expenditures, for example entertaining Client R.

The current management of company paper tickets is tedious and inefficient because for example if Employee V cannot attend the Event Y at the last minute the company's tickets in many cases go unused because it proves physically impossible to transfer the ticket to an alternative user. Via the WavServer 6 email notification system the administrator can be notified before the event that Employee V cannot attend the event and log in to the Company's WavMember account 5 and remotely transfer access privileges to the WavMember account 5 of another Employee of Company X who is available to use the event tickets. There is no need to keep track of paper tickets, or deal with inventory, or shipping etc. because all access privileges for Company X are stored on the WavServer 6 and can be managed in virtually real-time by the authorized administrator.

It is further contemplated that the fan 1 may purchase and manage multiple passes if desired. The fan 1 will have the ability, via his WavMember account 5, to choose which particular pass of several passes 4 associated with his account to activate for an upcoming live event. If a fan 1 has multiple passes 4, such as several different RFID ticket wristbands, a cell phone and a key fob, he logs into his WavMember account 5 and selects the particular pass 4 that will then become active for the particular upcoming event. The WavPass System will document the change in status.

As a security feature the WavServer 6 will allow only the selected active pass 4 to be used for access to the upcoming event, so if another person presents an inactive pass 4 not selected to be active by the fan 1 the request for access to the event will be denied and may be reported as lost or stolen to the fan 1 and/or event security. The fan 1 can keep a particular pass 4 active as the default pass for subsequent events or can manually activate the specific pass 4 desired for use before each event via his WavMember account 5. The WavServer 6 keeps track of each pass 4 owned by the fan 1 and provides the WavMember the ability via his personal Way Member account 5 to modify, change, add or deactivate the access privileges for any and all universal passes in his collection.

At any time, the WavPass system can obtain information from the system about purchase transactions performed by patrons using the system. Moreover, using conventional data mining techniques, the data contained in the system can be analyzed, for example, to analyze purchases of events, or goods in accordance with demographic information obtained from patrons during the establishment of the patron's account.

By mining the data of individual transactions on the WavPass account, one can analyze the spending habits and brand preferences of WavMembers. Sponsors of events can then market to both individuals and particular segments of the population deemed target customers that fit a certain profile i.e. demographics, household income, male or female, type of live events attending (rock or country) etc.

One key component of collecting data on how much people are spending at live events and their brand preferences is that the system can rate individuals on their behavior and value to a sponsor. For example the average consumer attends 1.5 events per year and spends roughly $70 at each event. If a particular account holder attends 5+ events per year and spend $150 per event that person is more valuable as a customer and will receive a higher ranking/rating. On the other hand, if a member only attends 1 event per year and spends just $25, that person would receive a lower Way Rating. The better customers can be given WavRewards, much like credit card companies or airlines do with cash back on purchases and free miles.

Essentially the Way Rating System is a merit based consumer rating system that rewards customers for their loyalty and patronage measured by a combination of how many events they attend, brand loyalty and preferences, how much they spend on event tickets, what events they attend, how much money they have on their WayBank account and how much they spend per event, etc.

For a comparable, think of the Way Rating System as the “Google Analytics” for live events. It is a powerful audience measurement tool and rewards system similar to the rewards programs offered by many casinos, airlines and banks, and could be thought of as a more precise Scarborough Report, which measures the lifestyles, shopping patterns, media behaviors, and demographics of American consumers locally, regionally, and nationally. Scarborough consumer insights are used by marketers and media professionals to develop successful programs that maximize return on marketing and sales investments.

1. Method of providing authorization for a purchaser to enter multiple events at different locations and times including
providing a computer system that can be remotely accessed by the purchaser;
establishing in the computer system an account uniquely associated with the said purchaser;
allowing the purchaser to purchase authorization to enter a particular event using the computer system and recording information of the purchase in the system in association with the purchaser's account;
providing the purchaser with data identifying the purchaser's account in the system in a form that the purchaser can take to the event embodied in a pass;
receiving at the computer system information identifying the account record obtained by reading the pass at the event;
interrogating the system to find out whether entry to the event has been purchased; and
providing a signal to the event location indicative of whether entry should be allowed.

2. A method according to claim 1 wherein the pass is in the form of a wearable bracelet.

3. A method according to claim 1 wherein the data identifying the purchaser's account is stored in a radio frequency chip embodied in the pass.

4. A method according to claim 1 including the steps of receiving data at the computer system indicating that the purchaser wishes to buy goods or services from a vendor using the account stored in the system;
interrogating the account to determine whether sufficient funds are available in the account to pay for the transaction;
depending on the result of the interrogation, providing a signal to the vendor approving or declining the purchase and, if the purchase is approved, retaining details of the purchase in the computer system associated with the purchaser's account.

5. A method according to claim 4 including the steps of allowing the purchaser to deposit funds into the account prior to using the pass to pay for purchases.

6. A method according to claim 1 wherein the step of establishing the account includes obtaining personal information from the user and storing it in the system in association with the purchaser's account.

7. A system for selling access to multiple events including
a computer system, which can be accessed by users from remote locations using a network;
a membership function of the computer system that receives personal information about a purchaser and establishes and maintains an account for the purchaser in the system including data identifying the account;
a booking function of the computer system which enables a purchaser to purchase access to one or a number of future events;
a memory function of the computer system which retains information about purchased access associated with the account of the purchaser;
an account data reception function of the computer system adapted to receive data obtained from a pass presented by the user at an event and containing readable data indicative of the account identity of a person seeking access to the event;
the computer system operated and arranged to query the purchased access data recorded in the system and associated with the transmitted account identity and to transmit information to the event location indicating whether admission should be allowed or denied.

8. A system according to claim 7 wherein the received account identifying data is derived from an RFID device in the pass.

9. A system according to claim 7 wherein the computer system permits a purchaser of an account to deposit funds into the account to be used for future financial transactions in which the account is identified by reading data stored on a pass provided by the system to the purchaser.

10. A system according to claim 9 wherein the system is also arranged to receive data indicative of an attempt by the user to purchase goods or services using the pass and to send a signal approving or declining the request based on whether or not sufficient funds are available in the account.

11. A system according to claim 7 wherein the system associates one account with a plurality of different passes, each of which can be separately identified by the system, and the booking function enables access to events purchased by a purchaser to be distributed among the different passes associated with the account.

12. A system according to claim 1 wherein the transmission of information to allow access to an event is recorded in the system and the system is arranged to deny access to a subsequent request for entry to the same event by the same pass.

13. A system according to claim 7 wherein the computer system notifies the event when a selected purchaser has been granted admission to an event.

14. A system according to claim 10 wherein the computer system notifies the event when a selected purchaser uses a pass to make a purchase at that event.

15. A method of obtaining information about the purchasing transactions of an attendee at a live event comprising:
providing a computer system;
establishing in the computer system a plurality of accounts, each one associated with a particular attendee of live events;
providing to each attendee a pass containing data identifying the account of that attendee;
allowing a purchase of goods or services at the event to be made using the pass and receiving data relating to the purchase at the computer system;
storing that data in the computer system in association with the attendee's account;
analyzing the stored data to obtain information about the attendee's purchases at the event.

16. A method according to claim 15 including the step of collecting demographic data from the attendee during the establishment of the attendee's account and storing that data in a searchable record in the system.

17. A method according to claim 15 including analyzing purchases made by multiple attendees at multiple events using the data stored in the system and further analyzing test data in association with demographic data about the attendees previously obtained from each attendee during the creation of that attendee's account.

18. A method according to claim 1 including the steps of allowing a purchaser to associate his account with a plurality of passes, each of which contains unique identity data, and to allocate different event access privileges to one or more of the said plurality of passes.

19. A method according to claim 1 including the step of recording in the system when entry to an event has been allowed based on the production of a particular pass at the event and thereafter providing a signal to deny access if the same pass is presented for entry to the same event.

20. A method according to claim 8 in which the allocation of entry privileges between different passes associated with an account is performed by the system on the basis of instructions received from the purchaser over a network.

21. A method according to claim 14 wherein the system delivers reward data to an attendee based on the analysis of the attendee's previous purchases at live events.
